(19) United States
(12) Patent Application Publication
(10) Pub. No.: US 2025/0104454 A1
(43) Pub. Date: Mar. 27, 2025

(54) Method for providing synthetic data

(71) Applicants: CARIAD SE, Wolfsburg (DE); ROBERT BOSCH GmbH, Stuttgart (DE)

(72) Inventors: Julio Borges, Stuttgart (DE); Praveen Anil Kulkarni, Bengaluru (IN); Attila Juhasz, Neckarsteinach (DE)

(21) Appl. No.: 18/895,832

(22) Filed: Sep. 25, 2024

(30) Foreign Application Priority Data
Sep. 27, 2023 (DE) 10 2023 126 304.8

(51) Int. Cl. G06V 20/70; G06T 7/12; G06T 11/00; G06V 10/25; G06V 10/764; G06V 20/54

(52) U.S. Cl. CPC G06V 20/70; G06T 7/12; G06T 11/00; G06V 10/25; G06V 10/764; G06V 20/54; G06T 2207/20081; G06V 2201/07

(57) ABSTRACT

The invention relates to a method (100) for providing synthetic data for use in machine learning, wherein the synthetic data comprise synthetic, photorealistic image information, said method comprising the following method steps:
generating (101) simulation data, wherein the simulation data are in the form of annotated data and are generated by a simulation environment,
determining (102) annotations from the generated simulation data,
generating (103) the synthetic data by means of semantic image synthesis (SIS) using the determined annotations as input for the semantic image synthesis (SIS),
annotating (104) the generated synthetic data based on an output from the simulation environment.

The invention relates to a method for providing synthetic data. The invention further relates to a computer program, a device, and a storage medium for this purpose.

### PRIOR ART

The generation of photorealistic synthetic data is an increasingly important task for machine learning in the field of computer vision. Several methods known from the prior art, such as generative adversarial networks (GANs) and diffusion models, can be used in the generation of photorealistic images.

One category of synthetic image generation is semantic image synthesis (abbreviated as SIS). In SIS, a semantic label map for each pixel describes which class the pixel belongs to. A generative model then learns how such a semantic label map—which describes a scene at the pixel level (e.g., a car on a road)—can be mapped to a photorealistic image. The semantic label map thus describes the scene intended to be generated by such a generative model.

Driving simulators are an important tool in the field of autonomous driving. They support the development, training, and validation of autonomous driving systems. Such tools provide open digital assets (city maps, buildings, vehicles) that create a customizable driving environment. Such simulation platforms as the open-source CARLA (see “Dosovitskiy, Alexey, et al. “CARLA: An open urban driving simulator.” Conference on robot learning. PMLR, 2017 (hereinafter abbreviated as [1]) support flexible specification of sensor suites, environmental conditions, complete control of all static and dynamic actors, map creation, and more. The control of all simulation-relevant elements, such as pedestrian behavior, weather, sensors, and traffic generation, is also possible. Desired and problematic edge cases (e.g., “a street full of pedestrians”) can therefore be generated. A further option is to simulate a variety of sensor annotations. The user can configure a variety of sensor systems, including GPS, depth sensors, LIDARs, and numerous cameras.

Known solutions can provide images rendered using a three-dimensional engine, but often lacking in photorealistic quality. In addition, such images also differ from the image data domains used to train or validate the downstream AI models.

### DESCRIPTION OF THE INVENTION

The object of the invention is a method having the features of claim 1, a computer program having the features of claim 9, a device having the features of claim 10, as well as a computer-readable storage medium having the features of claim 11. Further features and details of the invention follow from the dependent claims, the description, and the drawings. In this context, features and details which are described in connection with the method according to the invention are clearly also applicable in connection with the computer program according to the invention, the device according to the invention, as well as the computer-readable storage medium according to the invention, and respectively vice versa, so mutual reference is always made or may be made with respect to the individual aspects of the invention.

The object of the invention in particular is a method for providing synthetic data for use in machine learning, whereby the synthetic data preferably comprise synthetic, photorealistic image information and can thus can also be referred to hereinafter as photorealistic, synthetic data.

In the method according to the invention, the following method steps can be provided and particularly performed in a computer-assisted and/or automated manner:
generating simulation data, whereby the simulation data are in the form of annotated data and/or are able to be generated by a simulation environment such as CARLA (see [1]),
determining annotations from the generated simulation data, in particular by extracting the annotations from the generated simulation data, whereby the annotations can in the context of a simulation be automatically generated by the simulation environment for rendered image information about the generated simulation data and/or provided as part of the generated simulation data,
generating, in particular synthesizing, the synthetic data by means of semantic image synthesis (also referred to as SIS) using the determined annotations as input for the semantic image synthesis, whereby the semantic image synthesis preferably comprises at least one generative model, preferably a neural network and in particular a GAN (Generative Adversarial Network),
annotating the generated synthetic data based on an output from the simulation environment, in particular in order to provide the annotated synthetic data generated, i.e., the (synthesized) photorealistic image information comprising the associated annotations.

Therefore, one advantage of the invention can be that the photorealistic image information is not only able to be synthesized, but also automatically annotated. An option can thus be created for generating annotated photorealistic synthetic data and reducing the effort of manual annotation.

In addition, the simulation environment can be designed as a driving simulator in order to provide annotated synthetic data that can be used for machine learning in the field of at least partially automated driving.

Optionally, it is also provided that the output from the simulation environment comprises the determined annotations, whereby the determined annotations are preferably at least in part carried over into the generated synthetic data for the purpose of annotation. Synthetic data from such a simulation environment, and in particular an automated driving simulation environment, can be used for training and validating machine learning models for various tasks like at least partially automated and/or autonomous driving. This data type provides a wide variety of traffic scenarios which are quite difficult to observe and capture in the real world, and can play a critical role in modeling boundary situations for at least partially automated and/or autonomous driving. In conventional solutions, however, these data often lack the required photorealistic quality and are therefore easy to distinguish from actual data. Accordingly, training on the basis of such data is often also less successful. The advantage able to be achieved according to the invention is the ability to generate image information having improved photorealistic quality—thus resembling the real world—and to enable more effective “synthetic data expansion” for machine learning and for deep learning in particular. According to the invention, a combination of the simulation environment with semantic image synthesis (SIS), which is a category of generative modeling for deep learning, can be provided for this purpose. This makes it possible for semantic label maps (which are, e.g., extracted from the simulation environment) to be translated into photorealistic images.

It is also conceivable that the generated synthetic data comprise at least one photorealistic image (i.e., having the photorealistic image information in particular) and, based on the annotation of the generated synthetic data, the at least one photorealistic image can be classified in an image-element manner, in particular pixel-wise, whereby the classification preferably comprises object detection and/or semantic segmentation. This enables the synthesis of training data which are suitable for training a machine learning model for application to image data captured by an actual sensor.

For example, it can be provided that the determined annotations comprise at least one semantic label map and/or at least one bounding box. The annotations can thus be suitable for training and/or for validating a classification task and can in particular be used for the object detection and/or semantic segmentation of image information in the context of machine learning.

It can also be provided that the determination of the annotations based on the generated simulation data be performed as a function of at least one situation condition, whereby the situation condition is specific to a type of situation represented in the generated simulation data, preferably a traffic situation of a represented traffic scene. One example of such a condition follows: “street full of pedestrians”. This enables the capture of predefined edge cases and extreme cases.

Within the scope of the invention, it is also conceivable that the method steps be performed repeatedly in order to obtain a data quantity for the annotated generated synthetic data and/or to gradually increase the quantity in each method step, whereby the data quantity for use in machine learning can represent a variety of different situations and objects. This enables artificial synthesis of the data, which can be used to train and/or validate these situations and objects. For this purpose, these situations and objects can be simulated in advance by the simulation environment, and a driving simulator in particular, in order to obtain the appropriate annotations.

It can preferably be provided that the annotated generated synthetic data are used for machine learning by being used to train and/or validate a machine learning model, whereby the machine learning model is preferably trained for image classification (in particular pixel-wise), in particular object detection and/or semantic segmentation based on the annotations, preferably for an application in at least partially automated driving. A machine learning model trained in this way can be used to, based on an output from the machine learning model, at least partially automatically control, and/or accelerate, and/or brake, and/or steer a vehicle, such as a motor vehicle, and/or a passenger vehicle, and/or an at least partially automated vehicle. The machine learning model can for this purpose use, e.g., sensor and/or camera data from the vehicle as input.

It may also be possible for the simulation data generated to comprise simulated image information that preferably features no or less photorealism than the photorealistic image information of the synthetic data. The annotations of the simulation data generated can in this case annotate the simulated image information, in particular classifying it in a pixel-wise and semantic manner, whereby, out of the annotations and the simulated image information, preferably only the annotations are used as input for the semantic image synthesis. In other words, this enables the less realistic simulated image information to be exchanged with the photorealistic image information, while still obtaining the annotations.

The object of the invention is also a computer program, in particular a computer program product comprising commands that, when the computer program is executed by a computer, prompt the latter to perform the method according to the invention. The computer program according to the invention thereby provides the same advantages as described in detail with regard to a method according to the invention.

The object of the invention is also a device for data processing, which is configured to perform the method according to the invention. For example, a computer can be provided as the device which executes the computer program according to the invention. The computer can comprise at least one processor for executing the computer program. A non-volatile data storage means can also be provided, in which the computer program is stored and from which the computer program can be read by the processor for execution.

The object of the invention can also be a computer-readable storage medium comprising the computer program according to the invention and/or comprising instructions that, when executed by a computer, prompt the latter to perform the method according to the invention. The storage medium is, e.g., designed as a data storage means such as a hard disk, and/or a non-volatile memory, and/or a memory card. The storage medium can, e.g., be integrated into the computer.

The method according to the invention can furthermore be designed as a computer-implemented method.

Further advantages, features, and details of the invention follow from the description hereinafter, in which embodiments of the invention are described in detail with reference to the drawings. In this context, each of the features mentioned in the claims and in the description may be essential to the invention, whether on their own or in any combination. Shown are:

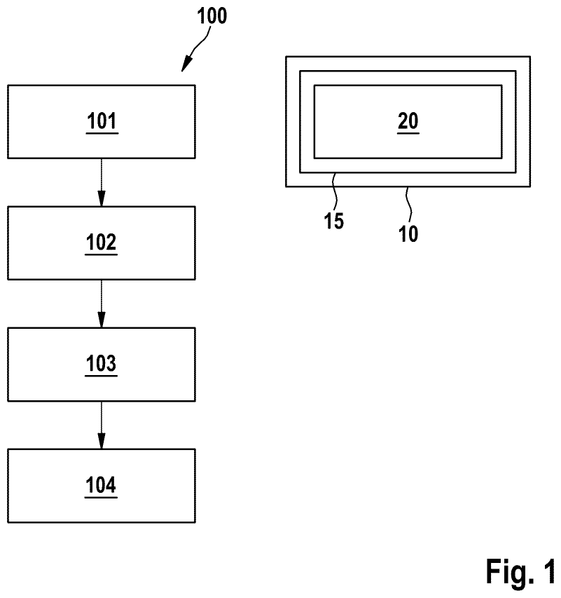

FIG. 1 a schematic illustration of a method, a device, a storage medium, as well as a computer program according to exemplary embodiments of the invention.

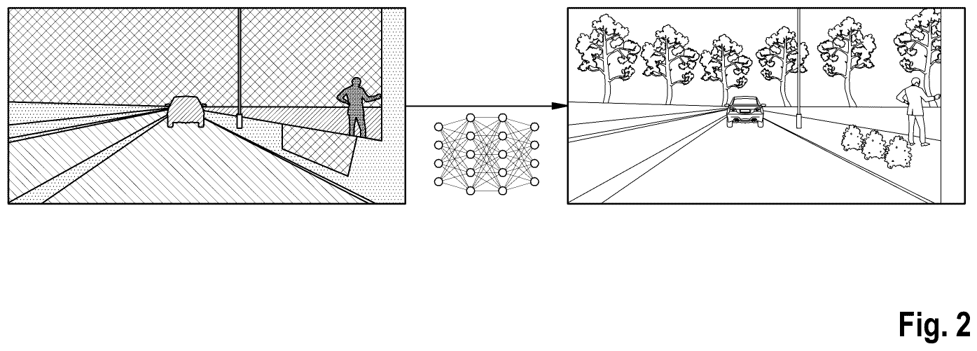

FIG. 2 a schematic illustration showing semantic image synthesis (SIS) according to exemplary embodiments of the invention.

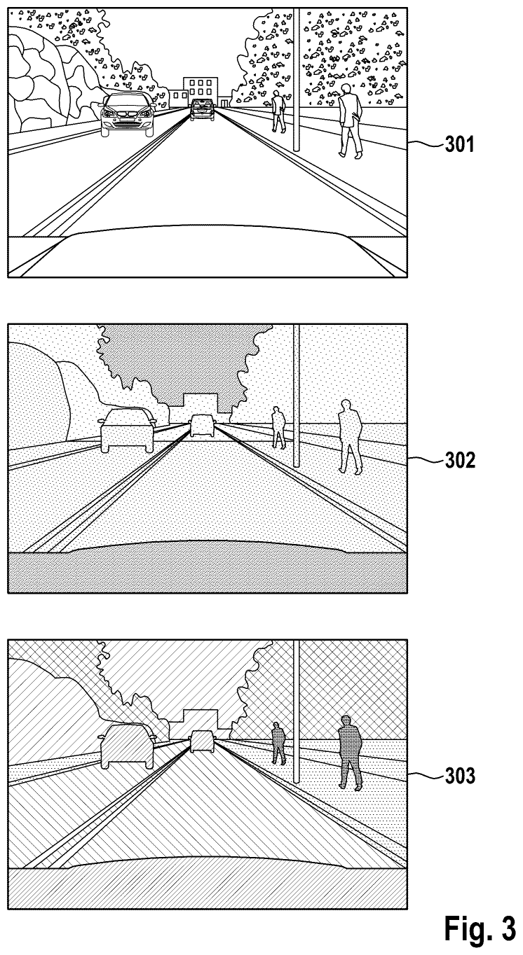

FIG. 3 by way of example, a simulated traffic scene according to exemplary embodiments of the invention.

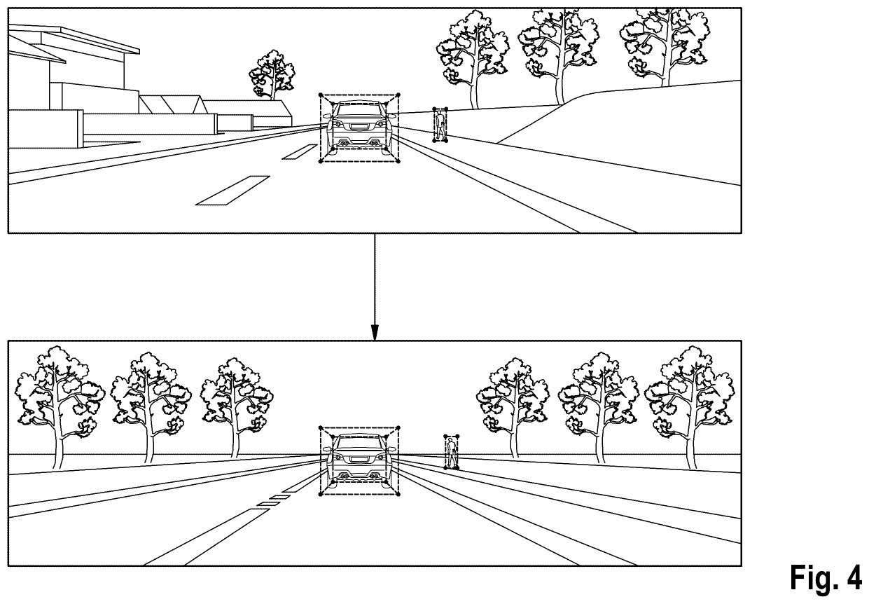

FIG. 4 by way of example, integration of a driving simulator into SIS according to exemplary embodiments of the invention.

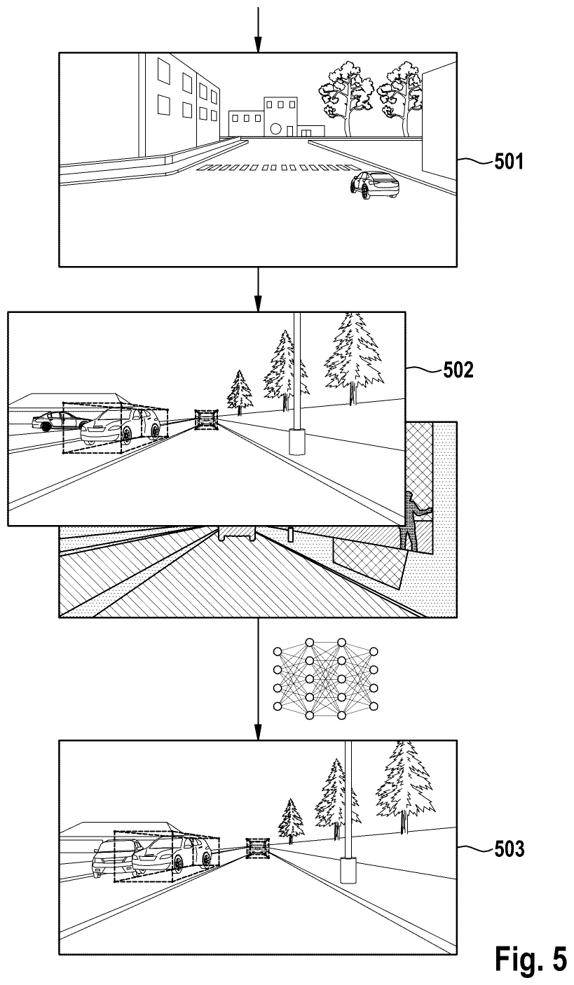

FIG. 5 a simplified illustration of a pipeline according to exemplary embodiments of the invention.

Photorealistic synthetic images are an important tool for data augmentation and validating artificial intelligence (AI) models for computer vision (CV). The use of this tool for training machine learning algorithms for at least partially automated and/or autonomous driving enables safety and reliability during operation of at an least partially automated and/or autonomous robot or vehicle.

In order to ensure the necessary security, it is sometimes necessary for such an AI model to be generalizable across various scenarios (e.g., tunnels or rare objects on the road) and robust against various edge cases (e.g., unusual weather or road conditions). In order to enable advantageous generalization and robustness of the model, these rare cases must be sufficiently present in the training data. However, these cases are conventionally quite difficult and complex to collect.

One option for increasing the representation of these rare cases in the training data is to enrich the data using synthetic data samples. Synthetic data can also be used to validate computer vision AI models by way of edge cases like bad weather, etc.

Generative models conventionally provide “only” synthetic images. For many downstream tasks in which synthetic data are used, many more annotations (hereinafter also referred to as “labels”) can under some circumstances be provided and optionally required, e.g. two-dimensional bounding boxes (for specific objects), and/or three-dimensional bounding boxes, and/or a radar point cloud, and/or a lidar point cloud, and/or a density depth, and/or the like. An object detector requires, e.g., images with two-dimensional bounding boxes for the objects being detected for training. By default, however, SIS only provides the image (and the semantic label map being used as input), which in this case would not be sufficient for training a two-dimensional object detector. On the other hand, the images provided by a simulation platform are often not qualitatively sufficient and, in particular, not photorealistic. In addition, due to what are referred to as “domain gaps”, such images are often not suitable for training real AI systems that require authentic-looking, photorealistic data points for their training and validation.

Schematically shown in FIG. 1 are a method 100, a device 10, a storage medium 15, as well as a computer program 20 according to exemplary embodiments of the invention. The method 100 is used to provide synthetic data for usage in machine learning. In this context, the synthetic data should comprise synthetic, photorealistic image information which can nevertheless be annotated in an automated manner. Simulation data can for this purpose first be generated according to a first method step 101, whereby the simulation data are in the form of annotated data and generated by a simulation environment. According to a second method step 102, the annotations can then be determined from the simulation data generated. According to a third method step 103, the synthetic data are generated by means of semantic image synthesis (SIS) using the determined annotations as input for the semantic image synthesis (SIS). The annotation of this generated synthetic data is made possible by means of a fourth method step 104, in which the annotation is based on an output from the simulation environment.

Therefore, one contribution of embodiments of the invention is the ability to provide photorealistic, synthetic images using all (or a required subset) of the annotations described hereinabove. In particular, exemplary embodiments of the invention provide an option for generating annotated photorealistic synthetic data, preferably by integrating SIS with a simulation platform.

A simulation platform such as a driving simulator can use ground-truth annotations such as semantic label maps, two-dimensional bounding boxes, and optionally also generate the other annotations (labels) specified hereinabove.

The determined annotations, such as the semantic label maps, can then be used as input for the semantic image synthesis (SIS). This is illustrated in FIG. 2A photorealistic image can in this way be synthesized using this input. The photorealistic image can then benefit from all of the other annotations delivered by the simulation platform, e.g. two-dimensional bounding box annotations, semantic segmentation, depth information (depth map), and the like. FIG. 3 shows examples of simulated image information 301, depth information 302, and semantic segmentation 303, which can be obtained by the simulation platform.

An example of a pipeline for providing the photorealistic synthetic data is described in reference to FIG. 5. The simulation parameters (such as camera parameters, map, traffic conditions, etc.) can initially be selected and established (see 501). The simulation platform (e.g., CARLA) can then be started. Based on the simulation environment of the simulation platform, annotated data can be sampled at a specific frequency (see 502). Optionally, the data may only be sampled if a specific condition (trigger) is satisfied. One example of such a condition follows: “street full of pedestrians”. This enables the capture of predefined edge cases and extreme cases. Moreover, all or a preselected set of ground-truth annotations from the simulation environment can be processed. Semantic label maps can then be extracted from the annotated data. The extracted semantic label maps can then be used as input for a pretrained SIS, such as OASIS. Photorealistic images can be generated in this way (random appearance, i.e. random noise/latent vectors; see 503). Optionally-instead of using a random selection-preselected latent vectors defining the appearance of the image (e.g., thunderstorm, weather, etc.) can be provided to the SIS. The photorealistic image generated can then be annotated using the information from the simulation environment. This is schematically illustrated in FIG. 4. The steps specified hereinabove can be repeated until a representative number of data samples have been collected as a data quantity for machine learning. The synthetic data patterns generated can then be used to train or validate AI models in a downstream task (e.g., object detection).

One advantage of exemplary embodiments of the invention is the ability to train SIS models using exactly the same image datasets that are used to train the downstream AI model—so synthetic images that are quite similar to the same downstream task area are able to be provided. In addition, the effort for labeling and data collection can be reduced. The annotated data can, e.g., comprise annotations in the form of two-dimensional and/or three-dimensional bounding boxes, and/or lidar and radar points and the like. It is also possible to control the the desired scenario parameters for which photorealistic synthetic data are desired (e.g., traffic density, number of pedestrians, etc.). It is also possible to “only” extract scenarios from the simulation environment that meet certain desired conditions, which are referred to as “trigger conditions”, e.g. desired edge cases such as “many pedestrians crossing a road”. This helps to focus on specific edge cases or other desired scenarios for the data generation process by filtering out these specified conditions.

The foregoing explanation of the embodiments describes the present invention only by way of examples. Insofar as technically practical, specific features of the embodiments may obviously be combined at will with one another without departing from the scope of the present invention.

1. A method for providing synthetic data for use in machine learning, wherein the synthetic data comprise synthetic, photorealistic image information, said method comprising the following method steps:
generating simulation data, wherein the simulation data are in the form of annotated data and are generated by a simulation environment,
determining annotations from the generated simulation data,
generating the synthetic data by means of semantic image synthesis (SIS) using the determined annotations as input for the semantic image synthesis (SIS),
annotating the generated synthetic data based on an output from the simulation environment.

2. The method according to claim 1,
characterized in that
the output from the simulation environment comprises the determined annotations, wherein the determined annotations are at least in part carried over into the generated synthetic data for the purpose of annotation.

3. The method according to claim 1,
characterized in that
the generated synthetic data comprise at least one photorealistic image, wherein, based on the annotation of the generated synthetic data, the at least one photorealistic image is classified in an image-element manner, in particular pixel-wise, wherein the classification preferably comprises object detection and/or semantic segmentation.

4. The method according to claim 1,
characterized in that
the determined annotations comprise at least one semantic label map and/or at least one bounding box.

5. The method according to claim 1,
characterized in that
the determination of the annotations based on the generated simulation data is performed as a function of at least one situation condition, wherein the situation condition is specific to a type of situation represented in the generated simulation data, preferably a traffic situation of a represented traffic scene.

6. The method according to claim 1,
characterized in that
the method steps are repeatedly performed in order to obtain a data quantity of the annotated generated synthetic data, which data quantity represents a variety of different situations and objects for use in machine learning.

7. The method according to claim 1,
characterized in that
the annotated generated synthetic data are used for machine learning by being used to train and/or validate a machine learning model, wherein the machine learning model is preferably trained for image classification, in particular object detection and/or semantic segmentation based on the annotations, preferably for application in at least partially automated driving.

8. The method according to claim 1,
characterized in that
the generated simulation data comprise simulated image information, which preferably features no or less photorealism than the photorealistic image information of the synthetic data, wherein the annotations of the generated simulation data annotate the simulated image information, wherein, out of the annotations and the simulated image information, only the annotations are used as input for the semantic image synthesis (SIS).

9. (canceled)

10. A device for data processing, which is configured to execute on one or more processors to:
generate simulation data, wherein the simulation data are in the form of annotated data and are generated by a simulation environment,
determine annotations from the generated simulation data,
generate the synthetic data by means of semantic image synthesis (SIS) using the determined annotations as input for the semantic image synthesis (SIS),
annotate the generated synthetic data based on an output from the simulation environment.

11. A computer-readable storage medium comprising commands that, when executed by a computer, prompt the computer to execute on the computer to:
generate simulation data, wherein the simulation data are in the form of annotated data and are generated by a simulation environment,
determine annotations from the generated simulation data,
generate the synthetic data by means of semantic image synthesis (SIS) using the determined annotations as input for the semantic image synthesis (SIS),
annotate the generated synthetic data based on an output from the simulation environment.
